(19) United States
(12) Patent Application Publication
(10) Pub. No.: US 2025/0024180 A1
(43) Pub. Date: Jan. 16, 2025

(54) FOLDABLE PATCH PANEL

(71) Applicant: Everest Media Solutions, Inc, Fort Lauderdale, FL (US)

(72) Inventors: Ziv SUSAN, Kibbutz Ramat Yohanan (IL); Huang WEILIANG, Ningbo, Zhejiang (CN)

(73) Assignee: Everest Media Solutions, Inc, Fort Lauderdale, FL (US)

(21) Appl. No.: 18/769,699

(22) Filed: Jul. 11, 2024

Related U.S. Application Data
(60) Provisional application No. 63/583,621, filed on Sep. 19, 2023.

(30) Foreign Application Priority Data
Jul. 14, 2023 (CN) 202321855704.8

(51) Int. Cl. H04Q 1/02; H01R 13/518

(52) U.S. Cl. CPC H04Q 1/131; H01R 13/518

(57) ABSTRACT

A foldable patch panel assembly includes a front frame comprising two front panels that are connected by a hinge assembly to thereby permit folding of the front panels relative to each other, wherein each front panel includes one or more slots for receiving therein one or more arrays of jacks; and a rear bracket comprising two bracket sections that are foldable relative to each other, wherein each bracket section comprises at least one clamp for receiving a cable therethrough; and wherein each bracket section further comprises an arm that is foldable relative to the bracket section and configured to snap into an outer end of the front panel.

### RELATED APPLICATIONS

This application claims the benefit of priority to Chinese Utility Model No. CN220325742U, filed Jul. 14, 2023, entitled “Network Distribution Frame Capable of Being Folded and Stored,” and U.S. Provisional Patent Application No. 63/583,621, filed Sep. 19, 2023, entitled “Foldable Storage Network Distribution Frame,” the contents of which are incorporated by reference as if fully set forth herein.

### FIELD OF THE INVENTION

The present disclosure relates to the design and construction of patch panels for network and telecommunication cables. More specifically, the present disclosure relates to a patch panel that is convertible from a folded position, such as during transport, to an opened position, for use when mounted.

### BACKGROUND OF THE INVENTION

In communications cabinets and racks, a multitude of cables are interconnected to one another through connectors. A cable organization unit typically has a tray or a shelf or a similar platform, which supports the connectors. Examples of cable organization units include patch panels and optical fiber distribution systems.

A patch panel is a device that houses cable connectors. A patch panel includes a number of jacks, usually of the same or similar type, for the use of connecting and routing circuits for monitoring, interconnecting, and testing circuits in a convenient, flexible manner.

A patch panel is commonly two-sided. The front of the patch panel is used for connections to relatively short wires or cables, and the rear of the patch panel usually provides for connection to relatively long wires or cables. This setup facilitates the performance of temporary alterations to the front of the patch panel without disturbing the connections in the rear. The patch panel facilitates interconnecting, monitoring, and circuit testing of equipment without necessitating costly switching equipment.

Patch panels are used for end-user lines or trunk lines and can be assigned to connected devices. The patch panel is the most important component in the management subsystem, and it is the hub that realizes the cross-connection of the two subsystems of vertical trunk and horizontal wiring. Patch panels are usually mounted on cabinets or walls. The patch panel can meet the needs of UTP, STP, coaxial cable, optical fiber, audio and video.

Early applications for patch panels were for telephone exchanges, where they are still used albeit in a more automated form. Patch panels are also used extensively in the entertainment industry, e.g., in recording and television studios. They are also used in concert halls to manage connections among equipment, e.g., microphones, speakers, and other electronic equipment. Patch panels are valued for such purposes not only for their convenience and relative cost effectiveness, but also because they make it easier to identify problems such as feedback, ground loops, and static.

A distribution frame is another device used to organize cables and fibers. In some usages, the term “patch panel” is used to refer to a device that is used to manage twisted pair copper cables, while the term “distribution frame” refers to a device that is used to distribute optical fibers.

### SUMMARY OF THE INVENTION

Existing patch panels tend to be manufactured in standard sizes and are fixed in their dimensions. For example, a conventional 24-port patch panel is approximately 19 inches long. This length is too large to fit within many mail slots and standard packaging sizes. As a result, such devices require a lot of packaging materials and occupy an inordinate amount of space during transportation. Such challenges are only magnified for larger patch panels, such as those which are used in data centers.

The present disclosure introduces a foldable patch panel assembly. During transport, the patch panel is shipped in its folded state. The end user unfolds and assembles the patch panel when he is ready to install the patch panel on a rack. As a result, the space required for packaging of the patch panel during transport may be cut in half, or even more.

The patch panel assembly includes a front frame. The front frame includes two front panels that are connected by a hinge assembly to thereby permit folding of the front panels relative to each other. Each front panel includes one or more slots for receiving therein one or more arrays of jacks.

The patch panel assembly further includes a folding rear bracket. The rear bracket includes two bracket sections that are foldable relative to each other. Each bracket section includes at least one clamp for receiving a cable therethrough. Each bracket section includes an arm that is foldable relative to the bracket section and configured to snap into an outer end of the front panel.

The hinge assembly may include one or more pairs of meshing gears arranged on interior ends of the front panels. Each pair of meshing gears may include one gear with splines and a second gear with grooves. The hinge assembly may also include foldable shaft plates configured between each of the front panels. The meshing gears and shaft plates help ensure that the opening of the frame from the folded position to the open position proceeds in a smooth manner.

Each front panel may include one or more indentations on an interior face thereof. When the front panels are in an opened position, the indentations combine to form a hole. An I-shaped stabilizer may be configured on the frame. The I-shaped stabilizer includes a vertical trunk having one or more holes therethrough, and horizontal bars at either end of the vertical trunk. The I-shaped stabilizer is slidable along the frame. When the frame is in the folded position, the stabilizer may be arranged entirely on one of the panels. When the frame is in the opened position, the vertical trunk is situated at a midpoint between the front panels, such that the holes of the vertical trunk align with the holes formed by the indentations. A locking cover including one or more pegs may be inserted into the holes formed by the indentations and the I-shaped stabilizer to thereby lock the patch panel assembly in the opened position.

Each front panel may include a mounting adapter on an outer end thereof. The mounting adapter includes one or more holes for receiving therein screws, for mounting the patch panel assembly on a rack.

One or more screw covers may be applied, to cover the screws used to mount the patch panel assembly onto the rack.

According to a second aspect, a method of assembling a foldable patch panel assembly, as previously described, is disclosed. The method includes: opening the frame from a folded position to an opened position; fixing the frame in the opened position; opening the bracket from a folded position to an opened position; and attaching the arms of the bracket to the outer ends of the front panel.

The hinge assembly may include one or more pairs of meshing gears arranged on interior ends of the front panels. In such embodiments, the step of opening the frame comprises rotating the gears in an intermeshed manner. The gears help ensure that the panels remain secure in place when they are in the folded position and that they open in a smooth manner without breaking when transitioning from the folded position to the opened position.

Optionally, each front panel may include one or more indentations on an interior face thereof, such that, when the front panels are in an opened position, the indentations combine to form one or more holes. An I-shaped stabilizer may be configured on the frame; wherein the I-shaped stabilizer comprises a vertical trunk having one or more holes therethrough and horizontal bars at either end of the vertical trunk; wherein the I-shaped stabilizer is slidable along the frame. In such embodiments, the fixing step further comprises: sliding the I-shaped stabilizer between a folded position, in which the stabilizer is arranged entirely on one of the front panels, and an opened position, in which the vertical trunk is at a midpoint between the front panels, such that the one or more holes of the vertical trunk align with the one or more holes formed by the indentations. The fixing step further comprises inserting one or more pegs into the one or more holes formed by the indentations and the one or more holes of the I-shaped stabilizer.

The assembling of the patch panel assembly may further include inserting one or more arrays of jacks into each of the front panels. The jacks may be inserted after the patch panel assembly is mounted on a rack.

The method of assembly may further includes mounting the frame onto a rack by attaching screws through mounting adapters on outer ends of the frame. Optionally, the screws may be covered with screw covers.

Compared with conventional patch panels, the presently described patch panel provides the following beneficial effects. First, the foldable patch panel occupies a relatively small volume during transportation, thereby enabling saving of packaging materials. In addition, the gears of the hinge system allow synchronous rotation of the panels during opening, enabling stable opening and closing. Furthermore, after opening the front frame and locking the frame with the I-shaped stabilizer and locking cover, the center of the frame may have the same appearance as the rest of the frame, thereby causing the overall structure to be straight and aesthetically pleasing.

Moreover, an array of jacks may be inserted into, and removed from, the frame, without any need to remove the frame from the rack on which it is mounted. This is convenient for customer installation, cable management, and maintenance.

### BRIEF DESCRIPTION OF THE DRAWINGS

FIG. 1 is a schematic diagram of a patch panel in an assembled position, according to embodiments of the present disclosure;

FIG. 2 is a schematic diagram of the patch panel of FIG. 1, and particularly illustrating the location of insertion of an array of jacks into a frame of the patch panel;

FIG. 3 is an exploded view of the patch panel;

FIG. 4 illustrates the frame of the patch panel in a folded position;

FIGS. 5A-5F illustrate steps in assembly of the patch panel from a folded position to an opened position and mounting of the patch panel onto a rack; and

FIGS. 6A-6C illustrate an alternative embodiment of a bracket of the patch panel.

### DETAILED DESCRIPTION OF THE INVENTION

The present disclosure relates to the design and construction of patch panels for network and telecommunication cables. More specifically, the present disclosure relates to a patch panel that is convertible from a folded position, such as during transport, to an opened position, for use when mounted.

The detailed description herein generally addresses embodiments of patch panels in which an array of jacks is arranged on a front face of the panel, with each jack configured to receive a cable. The jacks depicted in the Figures are typically used to receive twisted pair cables. However, as will be apparent in view of the description herein, the patch panel described herein operates equally well regardless of the shape of the jacks and the type of cables suited for connection in the patch panel. Thus, the cables that may be utilized within the patch panel include, for example, fiber optic cables and coaxial cables, with suitable modifications in the structure of the patch panel as required.

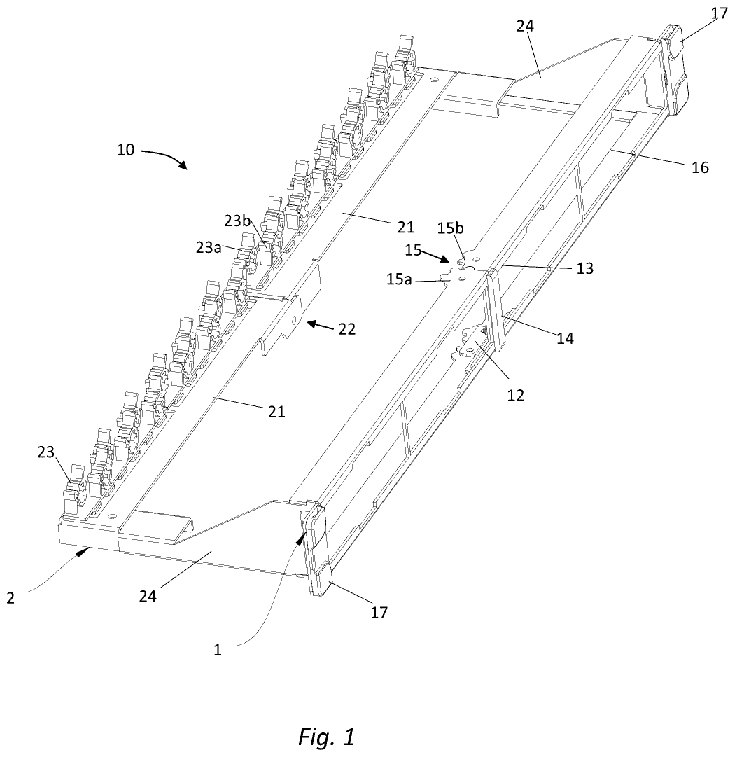

FIG. 1 illustrates a perspective view of a patch panel 10 in an assembled position. Patch panel 10 includes a frame 1 and a bracket 2, both of which are configurable between folded positions and opened positions. When the patch panel 10 is an assembled position, both the frame 1 and bracket 2 are opened.

Frame 1 includes two front panels 11. The front panels 11 are connected by a hinge assembly. In the illustrated embodiment, the hinge assembly facilitates folding of the front panels inward and outward. The hinge assembly includes folding shaft plates 12, which are present on the top and bottom of the connection between the front panels (only the bottom one is visible in FIG. 1). The hinge assembly further includes pairs of meshing gears 15. Each pair includes a first gear with splines 15a, and a second gear with grooves 15b. The splines 15a are aligned with the grooves 15b. When the front panels 11 are rotated relative to each other during a process of opening the frame 1, the intermeshing gears ensure that the rotation is performed smoothly and synchronously.

Each front panel 11 has one or more slots 16. In the illustrated embodiment, each front panel has two slots 16. The slots 16 are sized and shaped to receive therein a plurality of arrays of jacks.

Each front panel 11 further includes screw covers 17 mounted thereon. The screw covers 17 are overlaid onto mounting adapters on the outer ends of the front panels 11, and are used to cover screws which attach the front panels 11 to a rack, as will be shown further herein.

Still referring to FIG. 1, bracket 2 is mounted opposite the frame 1. Bracket 2 includes two bracket sections 21. The bracket sections 21 are generally symmetrical. The bracket sections 21 may be articulated with each other, or rotatable relative to each other around hinge 22. For example, the bracket sections 21 may be rotated downward, so that the bottoms of each of the bracket sections 21 are abutting or in contact.

Each bracket section 21 is provided with one or more clamps 23. The clamps 23 are used for holding and organizing wires that pass through the back end of the patch panel 10, in a manner known to those of skill in the art. In the illustrated embodiment, the clamps 23 are provided in two rows, in a staggered configuration. For example, as illustrated in FIG. 1, clamp 23a is in the rear row, and clamp 23b is in the front row, This configuration may be advantageous to enable easier threading of the wires through adjacent clamps 23. One advantage of using clamps 23 is that the clamps 23 obviate the need for cable ties. However, the clamps 23 may be snapped into the bracket 23 in a removable manner, so that if the user wishes to use cable ties, he may simply remove the clamps 23.

Arms 24 are configured at the ends of each bracket section 21. The arms are foldable relative to bracket section 21. In the extended position shown in FIG. 1, the arms 24 are fitted into slots in the outer ends of each respective front panel 11.

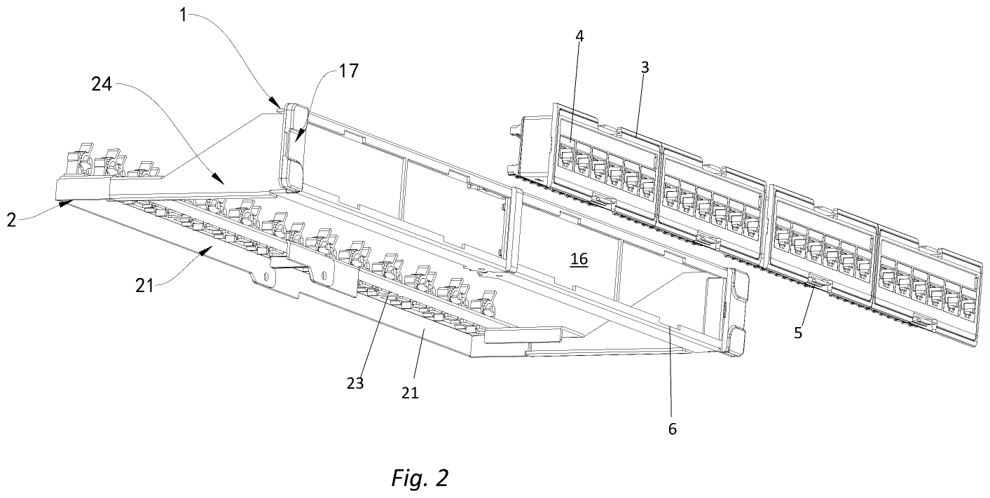

FIG. 2 illustrates arrays 3 of jacks 4 corresponding to the slots 16 of the front panels 11. In the illustrated embodiment, there are four arrays each having six jacks arranged in a row, for a total of twenty four jacks. Correspondingly, there are a total of twenty four clamps on bracket 2. Obviously, a different number of arrays 3, and a different number of jacks 4 per array, may also be implemented, without departing from the scope of the present disclosure. Each array has a protrusion 5 at the top and the bottom, which may be made of a flexible material such as a hard plastic; this protrusion 5 may be snap-fit into a corresponding cavity 6 in slot 16, in order to secure the array 3 in the slot 16. One advantage of this type of attachment mechanism is that the arrays 3 may be inserted and removed from the front, while the patch panel 10 is attached to a rack, without requiring removal of the patch panel. That said, other types of attachment of the array 3 to the front panel 11 may also be implemented.

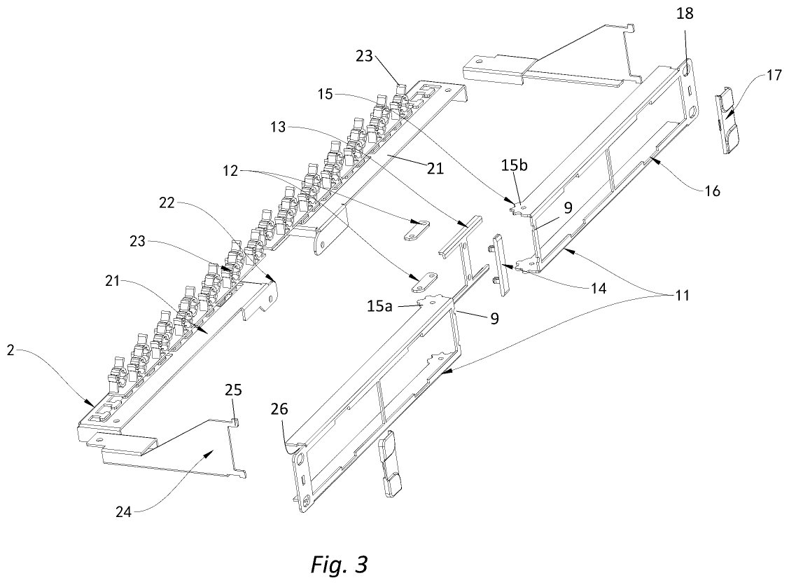

FIG. 3 illustrates an exploded view of the patch panel 10, which reveals various features of the patch panel 10 which are not visible in the assembled view of FIGS. 1 and 2.

In particular, with respect to the connection between bracket 2 and frame 1, it is possible to see that each arm 24 has upper and lower L-shaped protrusions or hooks 25 at an extended portion thereof. Each of these protrusions 25 fits with a corresponding slot 26 on the outer end of a front panel 11, to thereby connect the front panel 11 and the arm 24. The attachment of the front panels 11 and arms 24 is reversible, prior to mounting of the patch panel 10 on a rack; once the patch panel is mounted on a rack, the body of the rack is configured flush against the arms 24, and prevents removal of the arms 24 from the front panels 11.

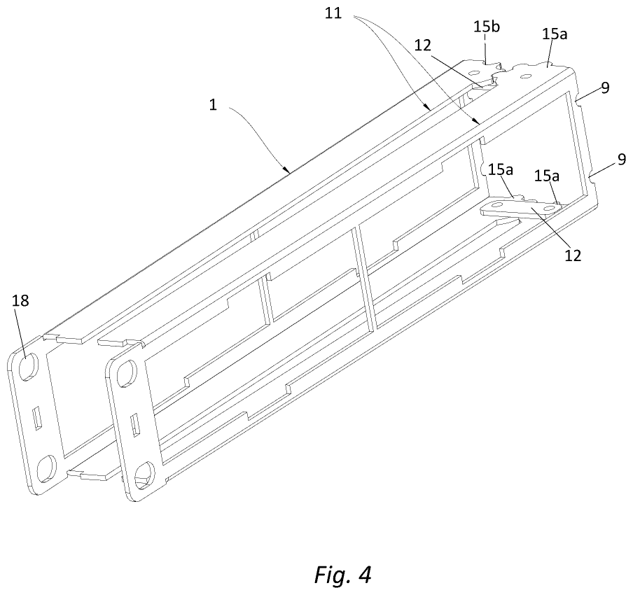

Also visible in FIG. 3 is the mechanism for locking the front panels 11 in place in the opened position. This mechanism includes multiple components, which are also visible in FIG. 4. Each of the front panels 11 has, at an interior edge thereof, one or more indentations 9. In the illustrated embodiment, the indentations are shaped as semicircles. When the front panels 11 are folded, these indentations are separate from each other, as seen in FIG. 4. When the front panels 11 are opened, however, the semicircles 9 are paired to form full circles. The locking mechanism further includes I-shaped stabilizer 13. The stabilizer includes a vertical trunk having one or more holes therethrough, and horizontal bars at either vertical end of the vertical trunk. The I-shaped stabilizer 13 may be attached to the frame 1 using, for example, a snap-fit attachment. When the frame 1 is in the folded position, the I-shaped stabilizer may be oriented entirely over one of the front panels 11. Theoretically, the I-shaped stabilizer 13 may be removed when the frame is in the folded position (as is shown in FIG. 4), as it has a function only in the opened position. However, maintaining the I-shaped stabilizer 13 on a different portion of the frame 1 is advantageous, as this helps ensure that the stabilizer 13 will not get lost or broken in transport. In some embodiments, the stabilizer 13 may be slidable along the frame 1 between a configuration of the folded position, in which the stabilizer 13 is over only one of the panels 11, and a configuration of the opened position, in which the stabilizer is over both of the panels 11.

When the frame 1 is in the opened position, the stabilizer 13 is centered over the junction between the two front panels 11. More specifically, the stabilizer 13 is positioned so that the holes in the vertical trunk are aligned with the holes formed by the joined indentations 9. A locking cover 14 with pegs is then placed over both the holes. The pegs are inserted into both the holes of the stabilizer 13 and in the hole formed by the combined indentations 9, to thereby lock the frame 1 in the opened position.

Patch panel 10 has various features for ensuring visual and aesthetic uniformity. As one example, each end of the front panel includes screw caps 17 for shielding the holes 18 that are used to attach the patch panel 10 to the rack. In addition, as seen in FIG. 1, the panels 11 generally appear to have I-shaped frames around each slot 16. As a result, the I-shaped stabilizer 13 and locking cover 14 blend into the overall look of the frame 1, rendering the entire patch panel aesthetically balanced and pleasing.

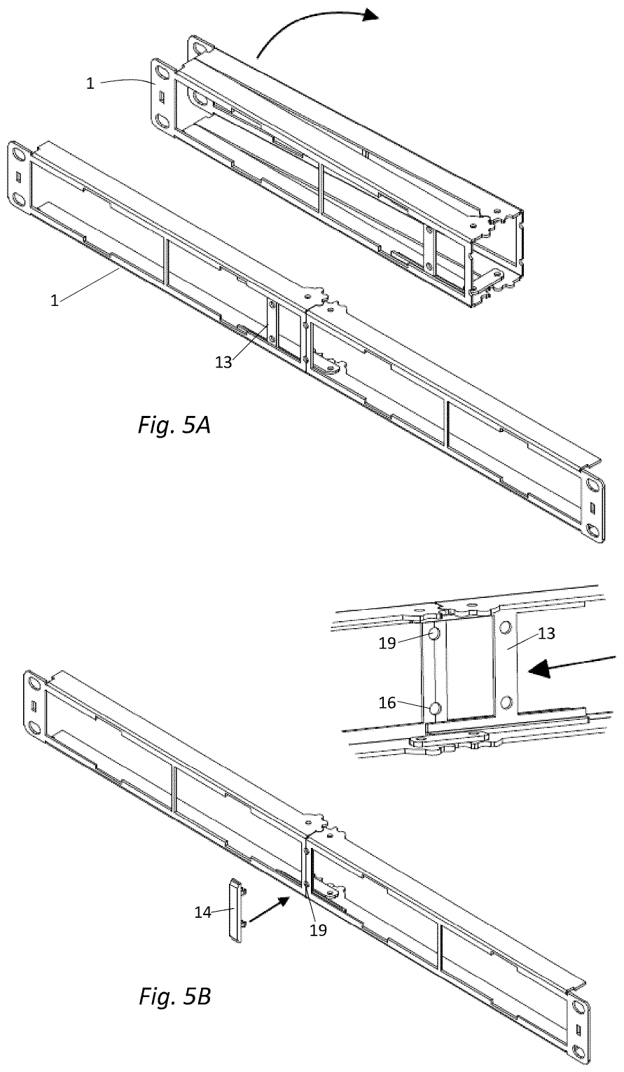

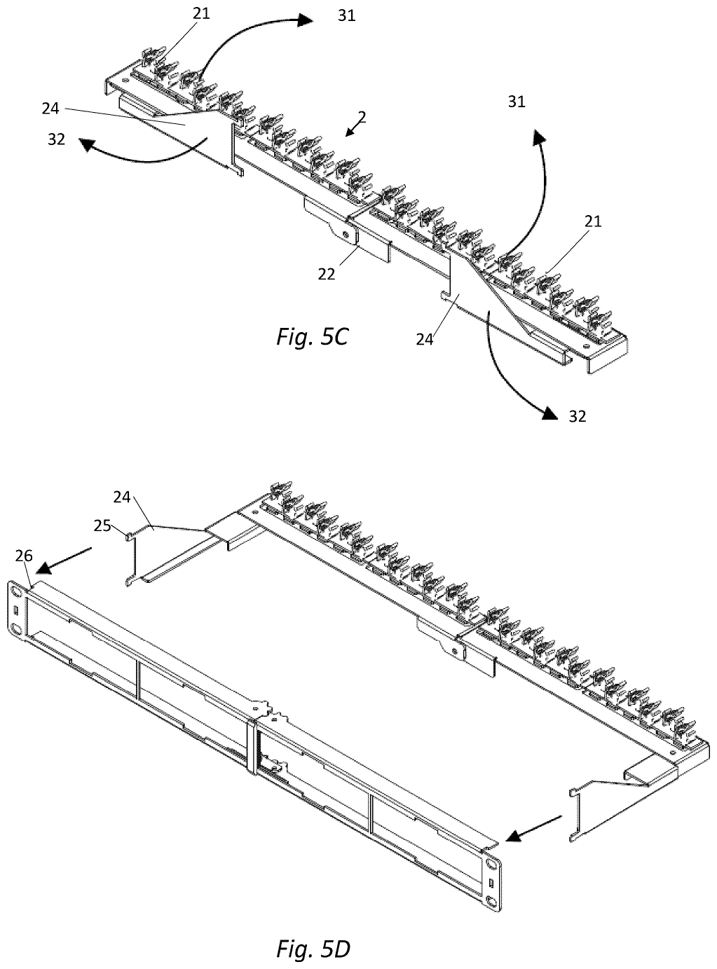

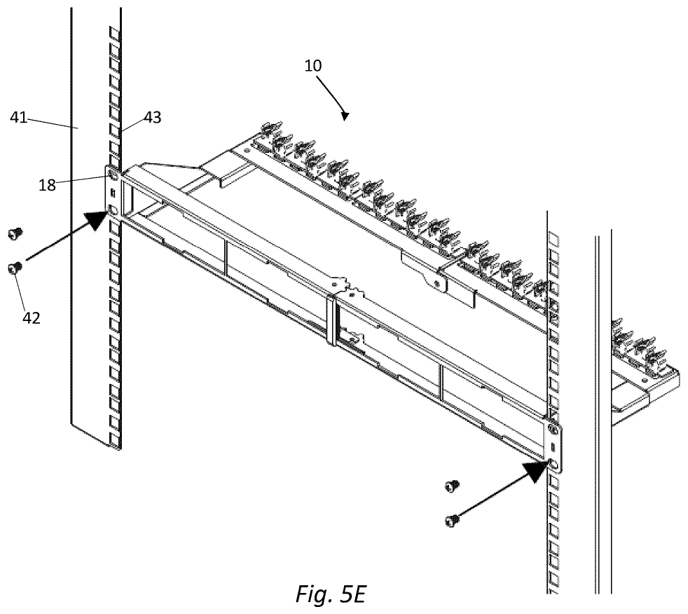

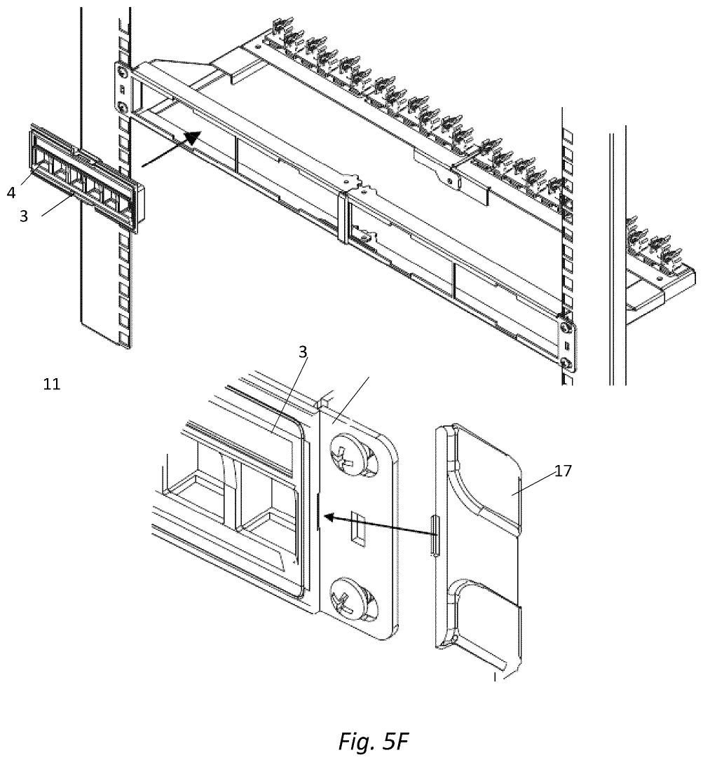

FIGS. 5A-5F illustrate a process of unfolding and installing patch panel 10, according to embodiments of the present disclosure.

At FIG. 5A, the frame 1 is opened from the folded position to the opened position. The I-shaped stabilizer 13 remains in its initial position, on only one of the panels 11.

At FIG. 5B, the I-shaped stabilizer 13 is moved (e.g., slid, or removed and replaced) between the initial, folded position of FIG. 5A, and a locking position in which the vertical trunk is at the midpoint between the front panels. The pegs of the locking cover are inserted into the holes 19 formed by the indentations and into the holes of the I-shaped stabilizer.

At FIG. 5C, bracket 2 is unfolded. The bracket sections 21 are rotated around hinge 22, in the direction of arrows 31. The arms 24 are rotated outward, in the direction of arrows 32.

At FIG. 5D, the protrusions 25 of arms 24 are inserted into the corresponding slots 26 on the frame 1, to thereby connect the bracket 2 and the frame 1.

At FIG. 5E, the patch panel 10 is mounted on a rack 41. Screws (or other fasteners) 42 are inserted through holes 18 of the frame 1 and holes 43 of the rack 41.

At FIG. 5F, the arrays 3 of jacks 4 are snapped into the front of the patch panel 10. Notably, the arrays 3 may be snapped in and removed while the patch panel 10 is mounted on the rack. Also, at the bottom of FIG. 5F, screw covers 17 are snapped into the panel 11, to thereby provide an aesthetic finish to the entire array.

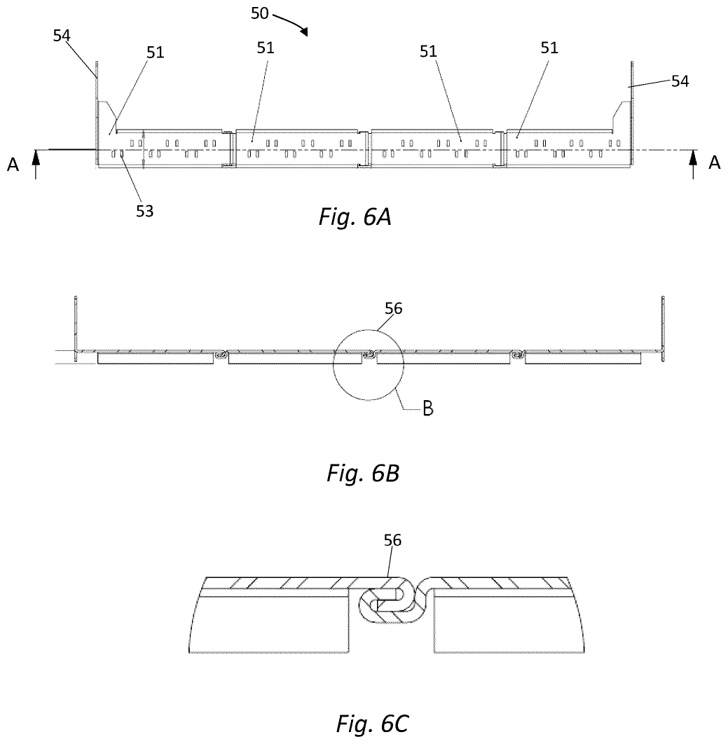

FIGS. 6A-6C illustrate another embodiment of a bracket 50. FIG. 6A is a top view of the bracket 50. The bracket 50 is made of four bracket sections 51, each with multiple slots 53 to which a clamp (not shown) may be attached.) Bracket 50 also includes arms 54 on either end thereof. The main difference between bracket 50 and the bracket of the previous embodiments relates to the manner of assembly of the different bracket sections. Specifically, rather than being rotatable relative to each other, the bracket sections may be removably attachable to each other. The manner of attachment 56 includes interlocking of curved end sections, as shown in FIG. 6B, which is a cross-section of FIG. 6A taken along cut A-A, and in FIG. 6C, which is a zoomed-in view of circle B of FIG. 6B. As may be evident to those of skill in the art, other manners of attachment and formation of the bracket are possible without departing from the teachings of the present disclosure.

In summary, the embodiments described herein enjoy various advantages over known patch panels. The patch panel described herein, including frame 1 and bracket 2, are foldable to occupy a relatively small volume during transportation, thereby saving packaging materials and providing environmental advantages. The front panels 11 exhibit dual-axis synchronous rotation, with smooth opening and closing. The I-shaped stabilizer and locking cover lock the front panels in the opened position, while exhibiting a straight and aesthetically pleasing finish. The arrays of jacks may be removable and replaceable through slots 16 while the patch panel is in place, without any need to remove the product. It is thus convenient for end users to install and manage the cables. The screw covers completely cover the mounting screws, so that the whole product is more integrated. The clamps obviate the need for cable ties, although should it be desired to use cable ties, the clamps may be removed.

Although embodiments of the present invention have been shown and described, for those of ordinary skill in the art, it is understood that without departing from the principle and spirit of the present invention, a variety of changes, modifications, substitutions and variations of these embodiments may be made, and the scope of the present invention is limited by the appended claims and equivalents.

1. A foldable patch panel assembly, comprising:
a front frame comprising two front panels that are connected by a hinge assembly to thereby permit folding of the front panels relative to each other, wherein each front panel includes one or more slots for receiving therein one or more arrays of jacks;
a rear bracket comprising two bracket sections that are foldable relative to each other, wherein each bracket section comprises at least one clamp for receiving a cable therethrough; and wherein each bracket section further comprises an arm that is foldable relative to the bracket section and configured to snap into an outer end of the front panel.

2. The foldable patch panel assembly of claim 1, wherein the hinge assembly comprises one or more pairs of meshing gears arranged on interior ends of the front panels.

3. The foldable patch panel assembly of claim 2, wherein each pair of meshing gears comprises one gear with splines and a corresponding gear with grooves.

4. The foldable patch panel assembly of claim 1, wherein the hinge assembly comprises foldable shaft plates configured between each of the front panels.

5. The foldable patch panel assembly of claim 1, wherein each front panel comprises one or more indentations on an interior face thereof, such that, when the front panels are in an opened position, the indentations combine to form one or more holes.

6. The foldable patch panel assembly of claim 5, further comprising an I-shaped stabilizer configured on the frame; wherein the I-shaped stabilizer comprises a vertical trunk having one or more holes therethrough and horizontal bars at either end of the vertical trunk; wherein the I-shaped stabilizer is movable between a folded position, in which the stabilizer is arranged entirely on one of the front panels, and a locking position, in which the vertical trunk is at a midpoint between the front panels, such that the one or more holes of the vertical trunk align with the one or more holes formed by the indentations.

7. The foldable patch panel assembly of claim 6, further comprising a locking cover comprising one or more pegs, wherein the pegs are insertable into the one or more holes formed by the indentations and the one or more holes of the I-shaped stabilizer to thereby lock the patch panel assembly in the opened position.

8. The foldable patch panel assembly of claim 1, wherein each front panel comprises a mounting adapter on an outer end thereof, wherein the mounting adapter comprises one or more holes for receiving therein screws for mounting the patch panel assembly on a rack.

9. The foldable patch panel assembly of claim 8, further comprising one or more screw covers for covering the screws used to mount the patch panel assembly onto the rack.

10. A method of assembling a foldable patch panel assembly, wherein the patch panel assembly comprises a front frame comprising two front panels that are connected by a hinge assembly to thereby permit folding of the front panels relative to each other, wherein each front panel includes one or more slots for receiving therein one or more arrays of jacks; and a bracket comprising two bracket sections that are foldable relative to each other, wherein each bracket section comprises at least one clamp for receiving a cable therethrough; and wherein each bracket section further comprises an arm that is foldable relative to the bracket section; the method comprising:
opening the frame from a folded position to an opened position;
fixing the frame in the opened position;
opening the bracket from a folded position to an opened position; and
attaching the arms of the bracket to the outer ends of the front panels.

11. The method of claim 10, wherein the hinge assembly comprises one or more pairs of meshing gears arranged on interior ends of the front panels; and the step of opening the frame comprises rotating the gears in an intermeshed manner.

12. The method of claim 10, wherein each front panel comprises one or more indentations on an interior face thereof, such that, when the front panels are in an opened position, the indentations combine to form one or more holes; and wherein an I-shaped stabilizer is configured on the frame; wherein the I-shaped stabilizer comprises a vertical trunk having one or more holes therethrough and horizontal bars at either end of the vertical trunk; wherein the I-shaped stabilizer is slidable along the frame, and the fixing step further comprises:
moving the I-shaped stabilizer from a folded position, in which the stabilizer is arranged entirely on one of the front panels, to a locking position, in which the vertical trunk is at a midpoint between the front panels, such that the one or more holes of the vertical trunk align with the one or more holes formed by the indentations; and
inserting one or more pegs into the one or more holes formed by the indentations and the one or more holes of the I-shaped stabilizer.

13. The method of claim 10, further comprising inserting one or more arrays of jacks into each of the front panels.

14. The method of claim 13, further comprising performing the inserting step after mounting the patch panel assembly onto a rack.

15. The method of claim 10, further comprising mounting the frame onto a rack by attaching screws through mounting adapters on outer ends of the frame.

16. The method of claim 15, further comprising covering the screws with screw covers.
